(19) United States
(12) Patent Application Publication
(10) Pub. No.: US 2012/0229414 A1
(43) Pub. Date: Sep. 13, 2012

(54) POSITION SENSING PANEL

(75) Inventor: Timothy ELLIS, (US)

(73) Assignee: QRG LIMITED

(21) Appl. No.: 13/043,032

(22) Filed: Mar. 8, 2011

(51) Int. Cl. G06F 3/045

(52) U.S. Cl. 345/174

(57) ABSTRACT

A position sensing panel has an array of parallel electrodes each formed by a repeating pattern of hollow shapes connected in series.

### BACKGROUND

A position sensor can detect the presence and location of a touch by a finger or by an object, such as a stylus, within an area of an external interface of the position sensor. In a touch sensitive display application, the position sensor enables, in some circumstances, direct interaction with information displayed on the screen, rather than indirectly via a mouse or touchpad. Position sensors can be attached to or provided as part of devices with a display. Examples of devices with displays include, but are not limited to, computers, personal digital assistants, satellite navigation devices, mobile telephones, portable media players, portable game consoles, public information kiosks, and point of sale systems. Position sensors have also been used as control panels on various appliances.

There are a number of different types of position sensors. Examples include, but are not limited to resistive touch screens, surface acoustic wave touch screens, capacitive touch screens, and the like. A capacitive touch screen, for example, may include an insulator coated with a transparent conductor in a particular pattern. When an object, such as a finger or a stylus, touches the surface of the screen there may be a change in capacitance. This change in capacitance may be sent to a controller for processing to determine where the touch occurred on the touch screen.

In a mutual capacitance configuration, for example, an array of conductive drive electrodes or lines formed on a surface of an insulator and conductive sense electrodes or lines formed on a surface of an insulator can be used to form a touch screen having capacitive sensing channels or nodes. A channel may be formed where a drive electrode and a sense electrode are in proximity. The electrodes may be formed on a common face of an insulator. The electrodes may be separated by an insulator to avoid electrical contact. The electrodes may be formed on opposite faces of an insulator. The sense electrodes may be capacitively coupled with the drive electrodes where they are in proximity. A pulsed or alternating voltage applied on a drive electrode may therefore induce a charge on the sense electrodes that are in proximity with the drive electrode. The amount of induced charge may be susceptible to external influence, such as from the proximity of a nearby finger. When an object touches the surface of the screen, the induced charge on each sense electrode on the screen can be measured to determine the position of the touch.

The sense and drive electrodes are connected to sense and drive electronic circuits by sense and drive connecting lines formed by conductive tracks or lines on the same surface of an insulator as the sense and drive electrodes.

### SUMMARY

A position sensing panel has an array of parallel electrodes each formed by a repeating pattern of hollow shapes connected in series.

### BRIEF DESCRIPTION OF THE FIGURES

The figures depict one or more implementations in accordance with the present disclosure, by way of example, not by way of limitation. In the figures, like reference numerals refer to the same or similar elements.

FIG. 1 illustrates schematically a cross-sectional view of an exemplary touch sensitive position sensing panel and a display;

FIG. 2 illustrates schematically a plan view of a drive electrode pattern useable in the touch sensitive position-sensing panel of FIG. 1;

FIG. 3 illustrates schematically a plan view of a sense electrode pattern useable in the touch sensitive position-sensing panel of FIG. 1;

FIG. 4 illustrates schematically a plan view of a combination of the drive electrode pattern of FIG. 2 and the sense electrode pattern of FIG. 3 useable together in the touch sensitive position-sensing panel of FIG. 1;

FIG. 5 illustrates schematically a plan view of another drive electrode pattern useable in the touch sensitive position-sensing panel of FIG. 1;

FIG. 6 illustrates schematically a plan view of a combination of the drive electrode pattern of FIG. 5 and the sense electrode pattern of FIG. 3 useable together in the touch sensitive position-sensing panel of FIG. 1;

FIG. 7 illustrates schematically a plan view of another drive electrode pattern useable in the touch sensitive position-sensing panel of FIG. 1;

FIG. 8 illustrates schematically a plan view of another drive electrode pattern useable in the touch sensitive position-sensing panel of FIG. 1;

FIG. 9 illustrates schematically a plan view of another sense electrode pattern useable in the touch sensitive position-sensing panel of FIG. 1;

FIG. 10 illustrates schematically a plan view of a combination of the drive electrode pattern of FIG. 8 and the sense electrode pattern of FIG. 9 useable together in the touch sensitive position-sensing panel of FIG. 1;

FIG. 11 illustrates schematically a detailed plan view of another drive electrode pattern useable in the touch sensitive position-sensing panel of FIG. 1;

FIG. 12 illustrates schematically a detailed plan view of a combination of the drive electrode pattern of FIG. 11 and the sense electrode pattern of FIG. 9 useable together in the touch sensitive position-sensing panel of FIG. 1; and

FIG. 13 illustrates schematically a detailed plan view of another drive electrode pattern useable in the touch sensitive position-sensing panel of FIG. 1.

### DETAILED DESCRIPTION

In the following detailed description, numerous specific details are set forth by way of examples. In order to avoid unnecessarily obscuring examples of the present disclosure, those methods, procedures, components, and/or circuitry that are well-known to one of ordinary skill in the art have been described at a relatively high level.

Reference is now made in detail to the examples illustrated in the accompanying figures and discussed below.

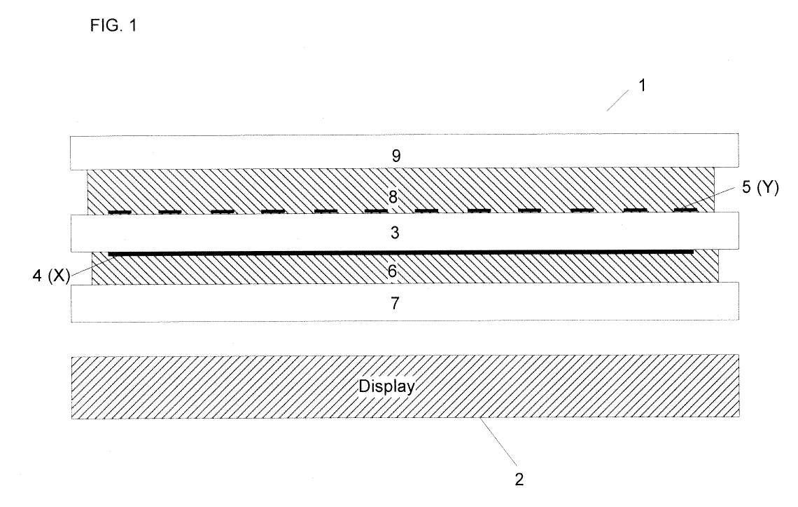

FIG. 1 illustrates an exemplary touch position-sensing panel 1 which overlies a display 2. In the illustrated example, the panel 1 includes an insulating substrate 3 having two opposing faces. Although touch sensors may implement other types of touch sensing, for discussion purposes, the drawing shows an example of a structure that may be used to implement a mutual capacitance type touch sensitive panel.

The panel 1 includes a number of electrodes 4 (X) and a number of electrodes 5 (Y) provided on opposite faces 3a and 3b of the substrate 3. The electrodes 4 (X), which may be on face 3b, may be arranged in one direction and the electrodes 5 (Y), which may be on face 3a, may be arranged in a direction different than the direction of electrodes 4 (X). In some examples, the electrodes 4 (X) may be arranged in a direction perpendicular to the direction of the electrodes 5 (Y). Other conductive tracks may be provided on the opposing faces 3a and 3b of the substrate 3. These other conductive tracks provide drive and sense connection lines for the electrodes 4 (X) and 5 (Y). These other conductive tracks are not shown in FIG. 1. An adhesive layer 6 may be between the electrodes 4 (X) and a covering sheet 7. Another adhesive layer 8 may be between the electrodes 5 (Y) and a covering sheet 9.

The covering sheet 7 and the adhesive layer 6 may encapsulate the electrodes 4 (X) and the other conductive tracks formed on face 3b. The covering sheet 9 and the adhesive layer 8 may encapsulate the electrodes 5 (Y) and the other conductive tracks formed on face 3a. The encapsulation of the electrodes 4 (X) and 5 (Y) and the other conductive tracks may provide protection from physical and environmental damage. In some examples, portions of the conductive tracks may be exposed to provide connection points for connection to external drive circuitry.

In the mutual capacitance example, electrodes 4 (X) may be drive electrodes provided on face 3b of the substrate 3, and electrodes 5 (Y) may be sense electrodes provided on the opposing face 3a. Capacitive sensing channels may be formed by capacitive coupling in the localized regions at and around where electrodes 4 (X) and 5 (Y) are in close proximity to each other, separated by the substrate 3.

One or both of the sets of electrodes 4 (X) and 5 (Y) may be formed from a conductive material such as a metal. The other conductive tracks in addition to the electrodes 4 (X) and 5 (Y) which are provided on the substrate 3, for example the drive and sense connection lines, may also be formed from a conductive material such as a metal. Suitable metals include copper, silver, gold, aluminum, tin and other metals used in conductive wiring.

In some examples, the touch position-sensing panel 1 may overlay a display 2 to implement a touch sensitive display device. Exemplary displays include liquid crystal displays, active matrix liquid crystal displays, electroluminescent displays, electrophoretic displays, plasma displays, cathode-ray displays, OLED displays, or the like. It will be appreciated that light emitted from the display may be able to pass through the touch position-sensing panel with minimal absorption or obstruction. The display 2 may be provided adjacent to the substrate 3 such that electrodes 4 (X) are arranged between the display 2 and the substrate 3. A gap may be formed between the display 2 and the covering sheet 7.

In some examples, the sense electrodes may be patterned in narrow lines to allow most of the light emitted from the display and incident on the sense electrode layer to pass through the electrode layer between the narrow metal lines. The narrow lines may be no more than 20 microns wide. An exemplary range may be 1-5 microns. Narrower lines have reduced visibility to the naked eye. By forming electrodes 4 (X) or 5 (Y) from narrow conductive lines, the position-sensing panel may be formed such that no more than about 10% of the active area is covered by the metal lines of the electrodes. Less coverage of the active area allows for greater transparency of the position-sensing panel reduces visibility of the electrodes to the human eye and reduces perceptible darkening or other loss of display quality. An exemplary coverage may be less than 5%.

In some examples, the electrodes 4 (X) may be formed from a clear conductive material and the electrodes 5 (Y) may be formed from narrow conductive metal lines. In other examples, the electrodes 4 (X) may be formed from narrow conductive metal lines and the electrodes 5 (Y) may be formed from a clear conductive material. In some examples, both of the sets of electrodes 4 (X) and 5 (Y), may be formed from a clear conductive material.

Indium tin oxide (ITO) is an example of a clear conductive material that may be used to form either one or both sets of electrodes 4 (X) and 5 (Y). In other examples, any other clear conductive material may be used, such as other inorganic and organic conductive materials. Examples of inorganic or organic conductive materials include antimony tin oxide (ATO), tin oxide, poly(ethylene dioxythiophene) (PEDOT) and other conductive polymers, carbon nanotube or metal nanowire impregnated materials, and the like. Opaque metal conductors may be used such as a conductive mesh, which may be of copper, silver or other conductive materials.

In one example, the substrate 3 may be transparent. In other examples, the covering sheets 7 and 9 may be transparent. In some examples, the adhesive layers 6 and 8 may be formed of an optically clear adhesive.

In some examples, the other conductive tracks, such as the drive and sense connection lines, may also be formed from a clear conductive material or narrow conductive metal lines, in a manner similar to the electrode layers 4 (X) and 5 (Y). For the other conductive tracks or parts of the other conductive tracks that lie outside a visible region of the display 2, the light-transmissibility of the other conductive tracks is of no concern. In some examples, the other conductive tracks, or parts of the other conductive tracks, which lie outside a visible region of the display 2 may be formed from continuous regions of a conductive material, such as a metal.

In some examples, a conductive ground plane may be located below the drive electrode layer 4 (X). In other examples, the conductive ground plane may be transparent.

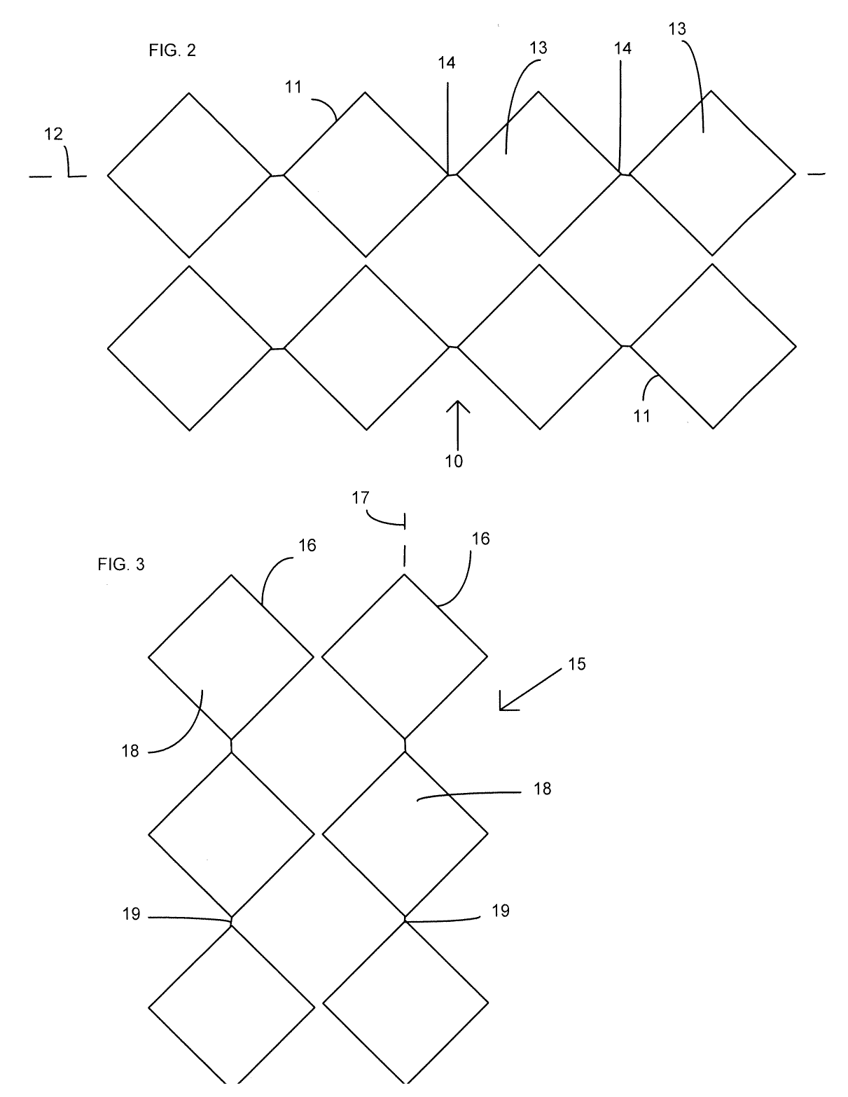

FIG. 2 illustrates an exemplary drive electrode pattern 10 which may be used in the touch position-sensing panel 1 to form the drive electrodes 4 (X). The drive electrode pattern 10 may be formed by a number of spaced apart parallel drive electrodes 11. The parallel drive electrodes 11 are illustrated extending horizontally in FIG. 2. Each drive electrode 11 may extend symmetrically on either side of a central axis 12. FIG. 2 shows portions of two parallel drive electrodes 11. Each drive electrode 11 may be formed by a repeating pattern of identical electrode shapes 13 connected in series by narrow conductive links 14. The narrow conductive links 14 may be arranged along the central axis 12 of the drive electrode 11. The drive electrode pattern 10 may extend across the whole of a sensing area of the position sensing panel 1.

In FIG. 2, each of the electrode shapes 13 making up a drive electrode 11 may be a square arranged so that a diagonal of the square is aligned with the central axis 12 of the drive electrode 11. Thus, the sides of the electrode shapes 13 making up the drive electrode 11 may be at a 45° angle to the central axis 12 of the drive electrode 11.

FIG. 3 illustrates a section of an exemplary sense electrode pattern 15 which may be used in the touch position-sensing panel 1 to form the sense electrodes 5 (Y). The sense electrode pattern 15 may be formed by a number of parallel sense electrodes 16 that are spaced apart. The sense electrodes 16 may extend vertically as shown in FIG. 3. Each sense electrode 16 may extend symmetrically on either side of a central axis 17. FIG. 3 shows portions of two sense electrodes 16. Each sense electrode 16 may be formed by a repeating pattern of identical electrode shapes 18 connected in series by conductive links 19. The conductive links 19 may be arranged along the central axis 17 of the sense electrode 16. The sense electrode pattern 15 may extend across the whole of a sensing area of the position sensing panel 1.

In FIG. 3, each of the electrode shapes 18 making up a sense electrode may be a square arranged so that a diagonal of the square is aligned with the central axis 17 of the sense electrode 16. Thus, the sides of the electrode shapes 18 making up the sense electrode 16 may be at a 45° angle to the central axis 17 of the sense electrode 16.

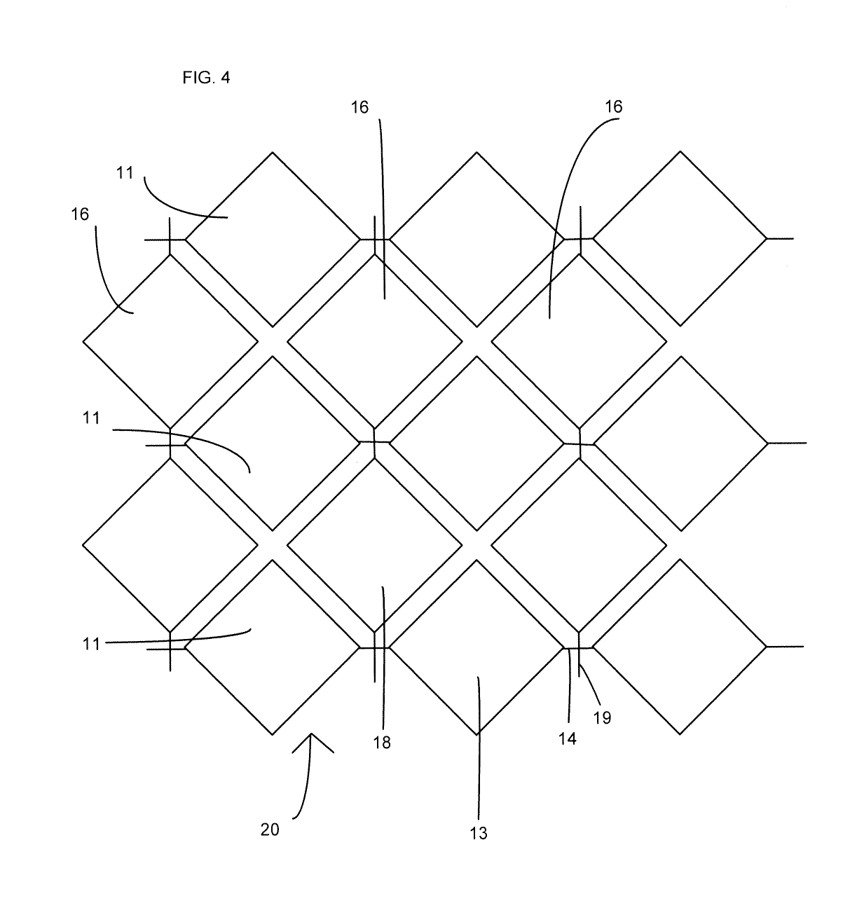

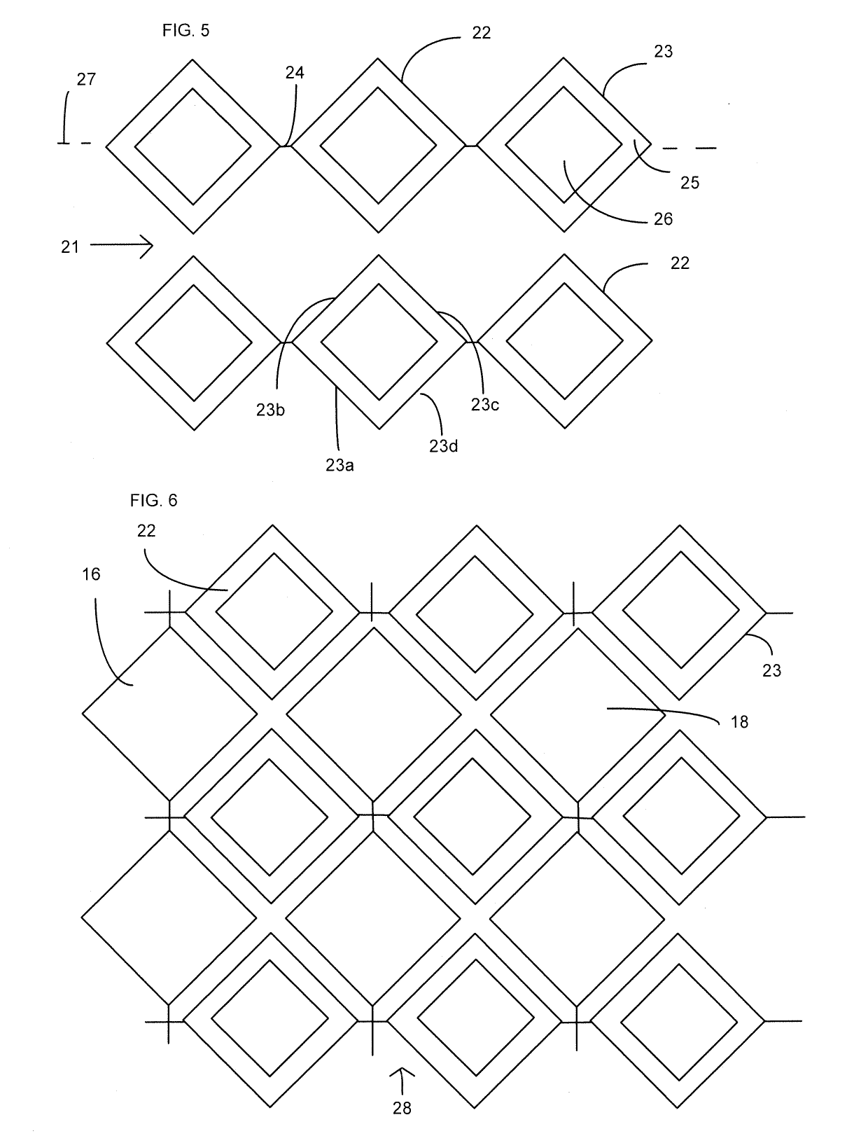

FIG. 4 illustrates a section of a combined electrode pattern 20 formed by the drive electrode pattern 10 of FIG. 2 and the sense electrode pattern 15 of FIG. 3 which may be used together in the touch position-sensing panel 1.

In some examples, the drive electrodes 11 and the sense electrodes 16 may be arranged on opposing faces 3a and 3b of a substrate 3 as illustrated in FIG. 1. In other examples, the drive electrodes 11 and the sense electrodes 16 may be arranged on the same face of a substrate. As shown in FIG. 4, the drive electrodes 11 may be arranged in a direction perpendicular to a direction in which the sense electrodes 16 are arranged. The combined electrode pattern 20 may extend across the whole of a sensing area of the position sensing panel 1.

The drive electrodes 11 and the sense electrodes 16 may be arranged so that the electrode shapes 13 of the drive electrodes 11 are located between the electrode shapes 18 of the sense electrodes 16.

The conductive links 14 of the drive electrodes 11 and the conductive links 19 of the sense electrodes 16 may cross over one another when arranged on opposing faces 3a and 3b of a substrate 3. When the drive electrodes 11 and sense electrodes 16 are formed on the same surface of a substrate, the drive electrode conductive links 14 and the sense electrode conductive links 19 will cross over one another, but separated so as not to come in electrical contact with each other.

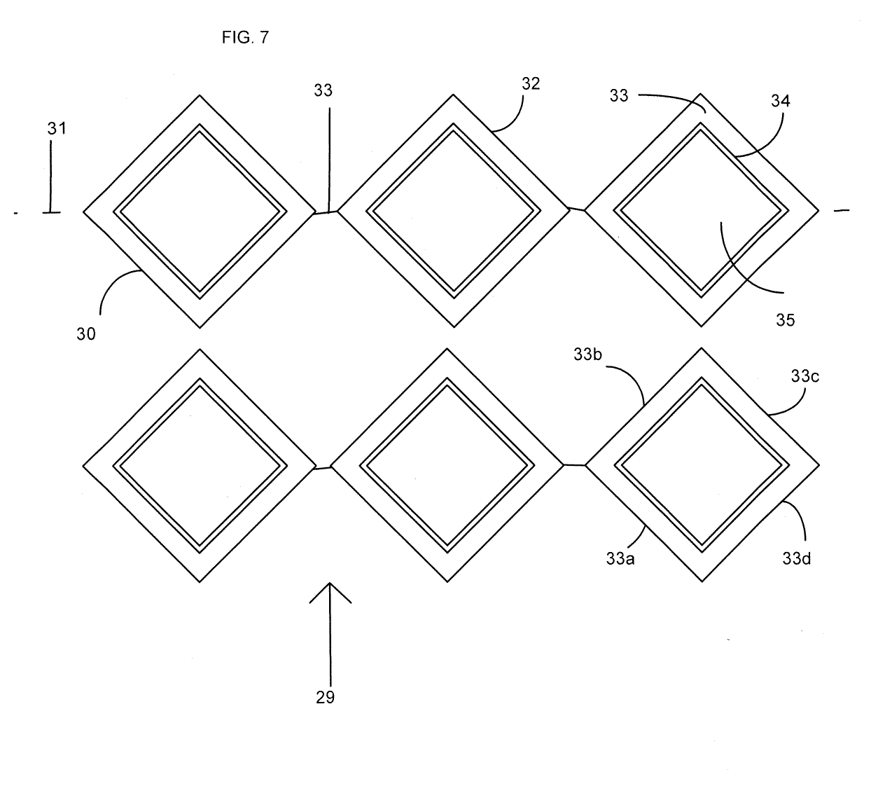

FIG. 5 illustrates a section of an exemplary drive electrode pattern 21 which may be used in the touch position-sensing panel 1 of FIG. 1 to form the drive electrodes 4 (X). The drive electrode pattern 21 may be formed by a number of spaced apart parallel drive electrodes 22. The parallel drive electrodes 22 are illustrated extending horizontally in FIG. 5. Each drive electrode 22 may extend symmetrically on either side of a central axis 27. FIG. 5 shows portions of two parallel drive electrodes 22. Each drive electrode 22 may be formed by a repeating pattern of electrode shapes 23 connected in series by conductive links 24. The conductive links 24 may be arranged along the central axis 27 of the drive electrode 22. In some examples, the drive electrode pattern 21 may extend across the whole of a sensing area of the position sensing panel 1.

Each of the electrode shapes 23 making up a drive electrode 22 may be a hollow square shape. Each of the electrode shapes 23 may be formed by four side portions 23a to 23d forming a square annulus or perimeter 25 around a square shaped central gap 26. The outer edges of the electrode shape 23 may have the same orientation as the edges of the central gap 26 so that the four side portions 23a to 23d may have substantially the same width and the four side portions 23a to 23d each may have substantially the same width.

Each of the electrode shapes 23 may be arranged so that a diagonal of each of the electrode shapes 23 and the central gap 26 are both aligned with the central axis 27 of each drive electrode 22. Thus, the inner and outer sides of the electrode shapes 23 making up each the drive electrode 22 may be at a 45° angle to the central axis 27 of each drive electrode 22.

FIG. 6 illustrates a section of a combined electrode pattern 28 formed by the drive electrode pattern 21 of FIG. 5 and the sense electrode pattern 15 of FIG. 3 which may be used together in the touch position-sensing panel 1 of FIG. 1.

As shown in FIG. 6, the drive electrodes 22 and the sense electrodes 16 may be arranged so that the hollow square electrode shapes 23 of the drive electrodes 22 are located between the square electrode shapes 18 of the sense electrodes 16.

A signal may be passed to a touching object, such as a finger, by the pulsed or alternating drive voltage applied to each drive electrode 22. The signal passed to the touching object may be produced by induced charges on the touching object as a result of capacitive coupling between the drive electrodes 22 and the touching object. When two or more connected objects, such as two or more different fingers of a user, touch the position sensing panel 1 at the same time, the signal passed to a touching object, such as a finger of a user, at one touch location as a result of capacitive coupling between the drive electrodes 22 and the touching object may be transmitted to another touching object, such as another finger of the user, at another touch location and induce a charge in the sense electrodes 18 in proximity to the other touching object at the other touch location. The induced charge in the sense electrodes 18 at the other touch location may make determination of the location of the one touch location difficult or inaccurate, and may even prevent the identification of a touch at the one touch location.

In some examples, if the one touch location and the other touch location are both on, or in proximity to, a common sense electrode, the induced charge in this common sense electrode at the two touch locations may be opposite in sense so that they may tend to cancel one another. As a result, the charge induced in the common sense electrode at the one touch location may tend to be cancelled out by the charge induced in the common sense electrode at the other touch location. Thus, in this instance, the other touch has anti-touch properties which tend to cancel out the effects of the one touch. The effects of the different touches may be mutually interfering so that the one touch cancels out the effects of the other touch in the same manner that the other touch cancels out the effects of the one touch as described above.

The effect of the mutual interference between multiple touches which make determination of the location of the touches difficult or inaccurate may be particularly severe with more than two touching objects. For example, when four different fingers of a user touch the position sensing panel 1 at the same time in four spaced apart locations arranged in a rectangle, the four touch locations are made up of two pairs of touch locations with the touch locations of each pair both being on, or in proximity to, a common sense electrode.

Mutual interference between multiple touches may be encountered when the touch position-sensing panel is a part of an electronic device which is not earthed, for example a portable electronic device.

The gaps in the hollow drive electrode shapes making up the drive electrodes may reduce the degree of capacitive coupling between the drive electrodes and a touching object and the magnitude of a signal passed to the touching object, such as a finger, by a pulsed or alternating drive voltage applied to each drive electrode.

The amount of capacitive coupling between the drive electrodes and sense electrodes may be mainly determined by the positions of the outer edges of the drive electrode shapes making up the drive electrodes relative to the edges of the sense electrodes. The absence of electrode material in the gaps in the electrode shapes may have little effect on the amount of capacitive coupling between the drive electrodes and sense electrodes. Accordingly, the absence of electrode material in the gaps in the drive electrode shapes may reduce the effect of mutual interference between multiple simultaneous touches without unacceptably reducing the capacitive sensing of each touch.

The width of the perimeters 25 of the electrode shapes may be varied. Making the perimeter narrower may reduce mutual interference. However, making the perimeter too narrow may result in an increase of the electrical resistance of the drive electrodes formed by the series of electrode shapes.

FIG. 7 illustrates an exemplary drive electrode pattern 29 which may be used in the touch position-sensing panel 1 to form the drive electrodes 4 (X) of FIG. 1. The drive electrode pattern 29 may be formed by a number of spaced apart parallel drive electrodes 30, which are illustrated extending horizontally in FIG. 7. Each drive electrode 30 may extend symmetrically on either side of a central axis 31. FIG. 7 shows portions of two parallel drive electrodes 30. Each drive electrode 30 may be formed by a repeating pattern of identical electrode shapes 32 connected in series by narrow conductive links 33. The narrow conductive links 33 may be arranged along the central axis 31 of the drive electrode 30.

Each of the electrode shapes 32 making up a drive electrode 30 may have a square shape and may include a square annular channel 34 extending around a square shaped central section 35. The edges of the electrode shape 32 may have the same orientation as the edges of central section 35 and the annular channel 34 so that the electrode shape 32 has a square shaped perimeter 33 having a constant width and formed by four side portions 33a to 33d each having substantially the same width, and a central portion 35 electrically isolated from the perimeter 33.

Each of the square electrode shapes 32 may be arranged so that a diagonal of each of the electrode shapes 32 and the central portion 35 are both aligned with the central axis 31. Thus, the outer edges of the electrode shapes 32 and the edges of the central portions 35 making up each drive electrode 30 may be at a 45° angle to the central axis 31.

The drive electrodes 30 are similar to the drive electrodes 22 modified to have the central gap 26 partially covered by a central portion 35. The drive electrodes 30 may be used in place of the drive electrodes 22 in the combined electrode pattern 28 illustrated in FIG. 6.

The electrically isolated portions of the drive electrode shapes making up the drive electrodes may reduce the effect of mutual interference between multiple simultaneous touches without unacceptably reducing the capacitive sensing of the electrodes. The electrically isolated portions of the drive electrode shapes may have the same effects as the gaps in the drive electrode shapes discussed previously.

In examples where touch position-sensing panel overlays a display to implement a touch sensitive display device and the drive electrodes 4 (X) and sense electrodes 5 (Y) are transparent or opaque, the drive electrode shapes having an electrically isolated central portion may provide a more uniform optical appearance than the drive electrode shapes with a central gap.

The width of the perimeters 33 of the electrode shapes may be varied.

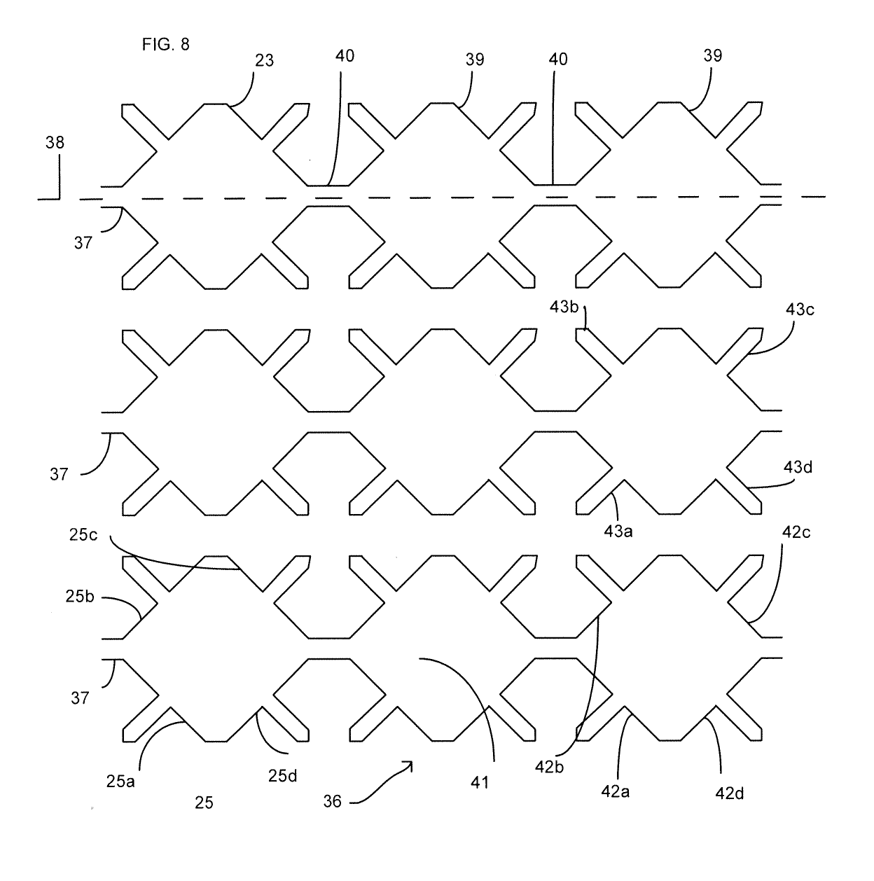

FIG. 8 illustrates an exemplary drive electrode pattern 36 which may be used in the touch position-sensing panel 1 to form the drive electrodes 4 (X) as shown in FIG. 1. The drive electrode pattern 36 may be formed by a number of spaced apart parallel drive electrodes 37. The parallel drive electrodes 37 are illustrated extending horizontally in FIG. 8. Each drive electrode 37 may extend symmetrically on either side of a central axis 38. Each drive electrode 37 may be formed by a repeating pattern of identical electrode shapes 39 connected in series by narrow conductive links 40. The narrow conductive links 40 may be arranged along the central axis 38.

Each of the electrode shapes 39 making up a drive electrode 37 may be a substantially square shape with projections. In some examples, the electrode shapes 39 may be formed by a substantially square central body 41 having four sides 42a to 42d. The central body 41 may be arranged so that a diagonal of the central body 41 is aligned with the central axis 38 of the drive electrode 37. Thus, each of the sides 42a to 42d of the central body 41 may be at a 45° angle to the central axis 38 of the drive electrode 37.

The vertices of the central body 41 which extend away from the central axis 38 may be truncated. Accordingly, the shape of the central body 41 may be substantially square.

Each of the four sides 42a to 42d of the central body 41 may have a respective protruding part or projection 43a to 43d extending radially outward. Each of the projections 43a to 43d may extend outward perpendicular to a respective side 42a to 42d. The projections 43a to 43d may be arranged so that if two lines are drawn between the points of contact of projections 43a to 43d and the respective sides 42a to 42d from which they project on opposite sides 42a to 42d of the central body 41, the lines may intersect at the center of the central body 41. In some arrangements where the length of the part of each side 42a to 42d obscured by a conductive link 40 is the same as the length of the part of that side 42a to 42d which has been removed by truncation, the projections 43a to 43d may project from the mid-points of the sides 42a to 42d.

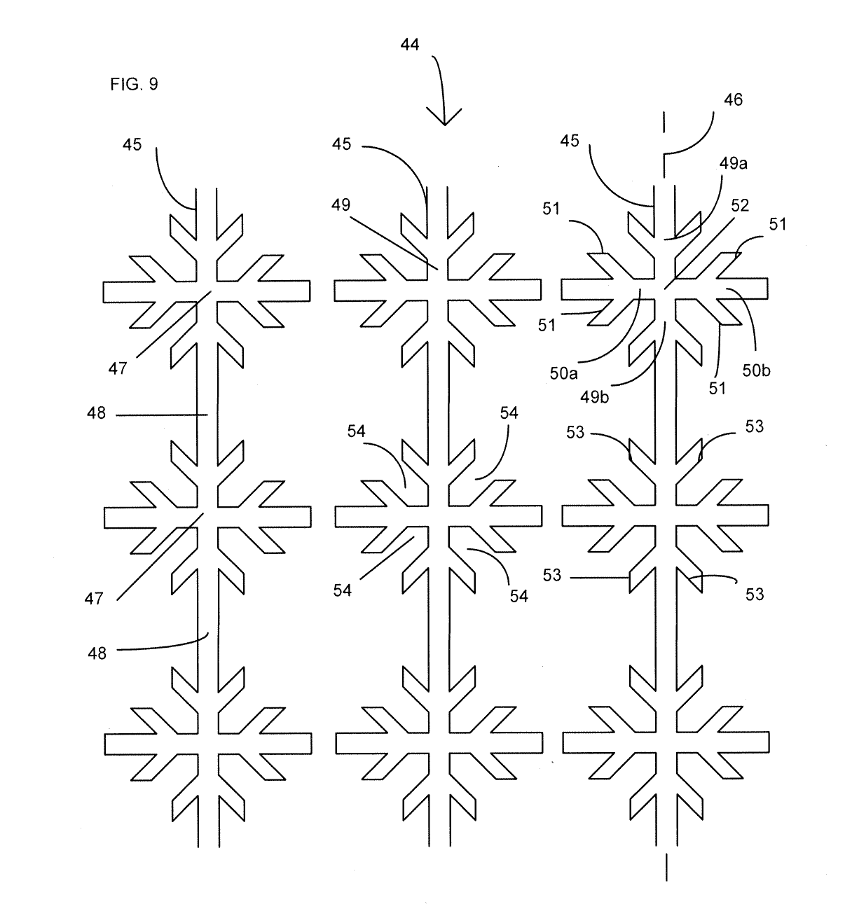

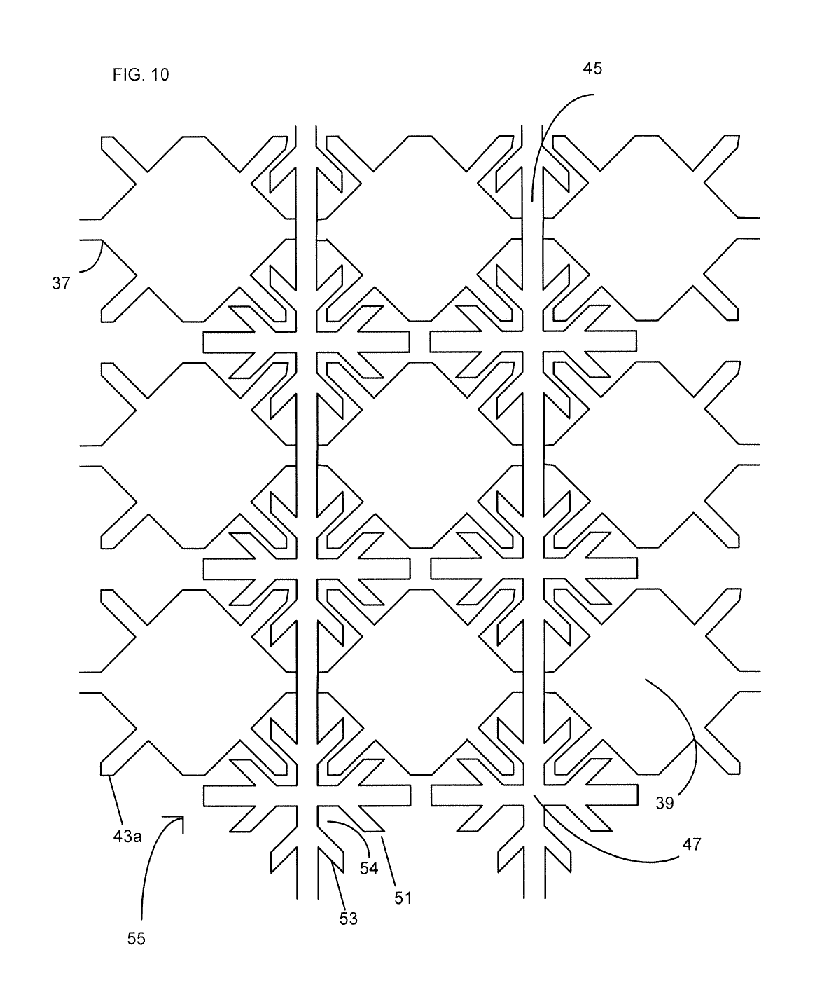

FIG. 9 illustrates a section of an exemplary sense electrode pattern 44 which may be used in the touch position-sensing panel 1 to form the sense electrodes 5 (Y) as shown in FIG. 1. The sense electrode pattern 44 may be formed by a number of spaced apart parallel sense electrodes 45. The sense electrodes 45 are illustrated extending vertically in FIG. 9. Each sense electrode 45 may extend symmetrically on either side of a central axis 46. FIG. 9 shows portions of three parallel sense electrodes 45. Each sense electrode 45 may be formed by a repeating pattern of identical electrode shapes 47 connected in series by conductive links 48. The conductive links 48 may be arranged along the central axis 46 of the sense electrode 45.

Each of the electrode shapes 47 making up a sense electrode 45 may be cross shaped and have a number of projections. Each of the electrode shapes 47 may have a body 49 formed by a strip extending along the central axis 46. The body 49 may be formed by two body parts 49a and 49b of equal length extending from a central point 52. Each of the electrode shapes 47 may have a pair of arms 50a and 50b extending outward in opposite directions from the body 49 at the central point 52. The arms 50a and 50b may be arranged perpendicular to the central axis 46.

Each of the arms 50a and 50b may have a pair of projections 51 extending outward from opposed sides of the arm 50a or 50b and in a direction away from the body part 49. In some examples, the projections 51 may be arranged at a 45° angle to the respective arm 50a or 50b from which they extend. Each pair of projections 51 may be arranged symmetrically about the respective arm 50a or 50b from which they extend. In other examples, the angle at which the projection extends may be greater than or less than 45°.

Each of the body parts 49a and 49b may have a pair of projections 53 extending outward from opposed sides of the body part 49a or 49b and in a direction away from the arms 50a and 50b. Each of the projections 53 may be arranged at a 45° angle to the respective body part 49a or 49b from which they extend. Each pair of projections 53 may be arranged symmetrically about the respective body part 49a or 49b from which they extend.

Passages 54 may be defined between adjacent projections 51 and projections 53.

FIG. 10 illustrates a combined electrode pattern 55 formed by the drive electrode pattern 36 of FIG. 8 and the sense electrode pattern 44 of FIG. 9 which may be used together in the touch position-sensing panel 1 of FIG. 1.

As is shown in FIG. 10, the drive electrodes 37 of FIG. 8 may be arranged in a direction perpendicular to a direction in which the sense electrodes 45 of FIG. 9 are arranged.

In some examples, the drive electrodes 37 and the sense electrodes 45 may be arranged so that the electrode shapes 39 of the drive electrodes 37 are located between the electrode shapes 47 of the sense electrodes 45. In other examples, the drive electrodes 37 and the sense electrodes 45 may be arranged so that the projections 43a to 43d of the drive electrodes 37 are located in the passages 54 defined between the projections 51 and 53 of the sense electrodes 47.

The interleaving of the projections 43a to 43d of the drive electrodes 37 and the projections 51 and 53 of the sense electrodes 47 may increase the capacitive coupling between the drive electrodes 37 and the sense electrodes 47. This may improve signal to noise levels, and may allow the location of a touch to be more accurately determined.

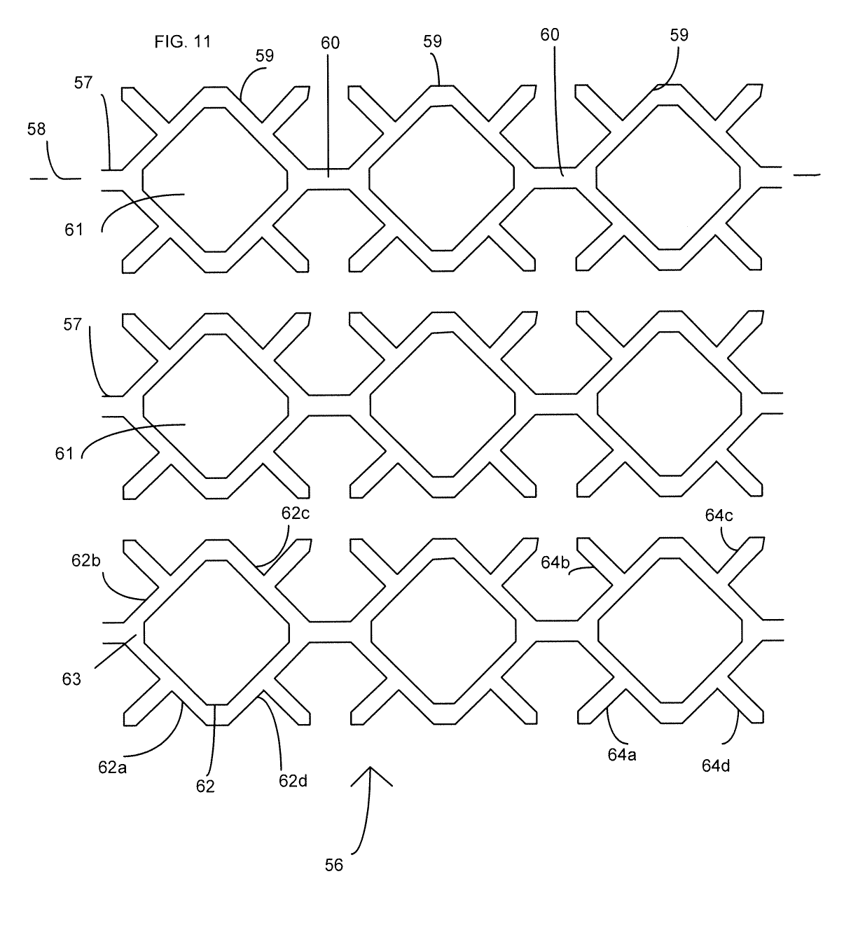

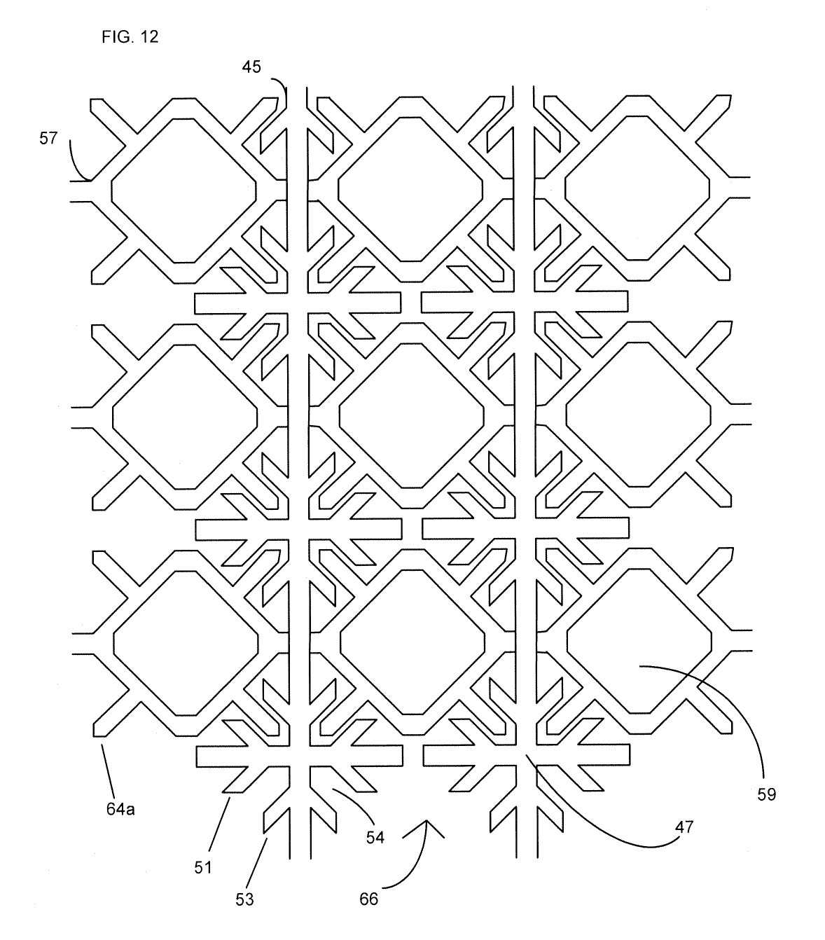

FIG. 11 illustrates an exemplary drive electrode pattern 56 which may be used in the touch position-sensing panel 1 to form the drive electrodes 4 (X) as shown in FIG. 1. The drive electrode pattern 56 may be formed by a number of spaced apart parallel drive electrodes 57. The parallel drive electrodes 57 are illustrated extending horizontally in FIG. 11. Each drive electrode 57 may extend symmetrically on either side of a central axis 58. FIG. 11 shows portions of three parallel drive electrodes 57. Each drive electrode 57 may be formed by a repeating pattern of identical electrode shapes 59 connected in series by conductive links 60. The conductive links 60 may be arranged along the central axis 58 of the drive electrode 57.

Each of the electrode shapes 59 making up a drive electrode 57 may be a hollow substantially square shape with projections. Each of the electrode shapes 59 may have the same external shape as the electrode shapes 39 illustrated in FIG. 8. In some examples, the electrode shapes 59 have a substantially square central gap 61. Each of the electrode shapes 59 may be formed by a substantially square hollow central body 62. Each central body 62 may be formed by four side portions 62a to 62d forming an annulus or perimeter 63 around the central gap 61. The outer edges of the central body 62 may have the same orientation as the edges of the central gap 61 so that the perimeter 63 has a constant width and the four side portions 62a to 62d each have the same width. In other examples, the central gap 61 covers an area greater than the combined area covered by the four side portions 62a to 62d.

Each of the electrode shapes 59 may be arranged so that a diagonal of each of the central body 62 and the central gap 61 are both aligned with the central axis 58. Thus, the inner and outer sides of the four side portions 62a to 62d of each electrode shape 59 making up the drive electrode 57 may be at a 45° angle to the central axis 58.

The vertices of the central body 62 and the central gap 61 of the electrode shape 59 which extend away from the central axis 58 may be truncated. Accordingly, the shape of the central body 62 and the central gap 61 may be substantially square.

Each of the four side portions 62a to 62d of the central body 62 may have a respective protruding part or projection 64a to 64d extending radially outward. Each of the projections 64a to 64d may extend outward perpendicular to a respective side portion 62a to 62d. The projections 64a to 64d may be arranged so that if two lines are drawn between the points of contact of projections 64a to 64d and the respective side portions 62a to 62d from which they project on opposite sides of the central body 62, these lines may intersect at the center of the central body 62. In some examples where the length of the part of each side 62a to 62d obscured by a conductive link 60 is substantially the same as the length of the part of that side 62a to 62d which has been removed by truncation, the projections 64a to 64d may project from the mid-points of the side portions 62a to 62d.

In some examples, the width of each side portion 62a to 62d is substantially equal to the width of each projection 64a to 64d.

FIG. 12 illustrates a combined electrode pattern 66 formed by the drive electrode pattern 56 of FIG. 11 and the sense electrode pattern 44 of FIG. 9 which may be used together in the touch position-sensing panel 1 of FIG. 1.

The drive electrodes 57 may be arranged in a direction perpendicular to a direction in which the sense electrodes 45 are arranged. As shown in FIG. 12, the drive electrodes 57 and the sense electrodes 45 may be arranged so that the electrode shapes 59 of the drive electrodes 57 are located between the electrode shapes 47 of the sense electrodes 45.

The drive electrodes 57 and the sense electrodes 45 may be arranged so that the projections 64a to 64d of the drive electrodes 57 are located in the passages 54 defined between the projections 51 and 53 of the sense electrodes 47. The interleaving of the projections 64a to 64d of the drive electrodes 57 and the projections 51 and 53 of the sense electrodes 47 may increase the capacitive coupling between the drive electrodes 57 and the sense electrodes 47.

In the example of FIG. 11, the width of the perimeters 63 of the electrode shapes 59 may be varied. In some examples, the width of the perimeter 63 may be in the range 0.2 mm to 0.5 mm. For example, the width of the perimeter 63 may be 0.3 mm.

In some examples, the width of the projections 64a to 64d of the electrode shapes 59 may be varied. In other examples, the width of the projections 76a to 76d may be the same as the width of the perimeter 75. In one example, the width of the projections 64a to 64d may be in the range 0.2 mm to 0.5 mm. In another example, the width of the projections 64a to 64d may be 0.3 mm.

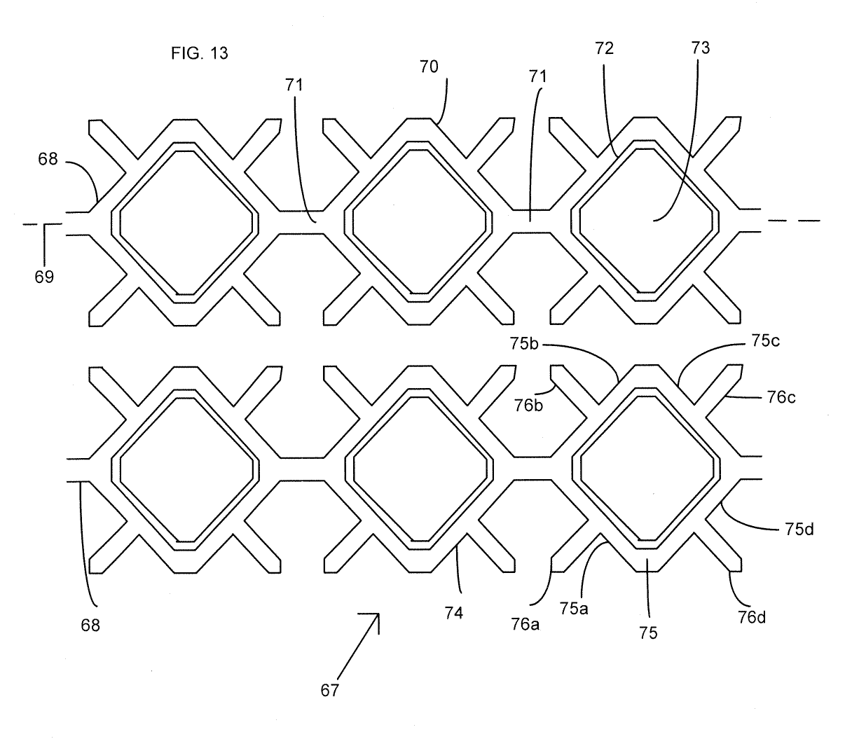

FIG. 13 illustrates a section of an exemplary drive electrode pattern 67 which may be used in the touch position-sensing panel 1 to form the drive electrodes 4 (X) as shown in FIG. 1. The drive electrode pattern 67 may be formed by a number of spaced apart parallel drive electrodes 68, which are illustrated extending horizontally. Each drive electrode 68 may extend symmetrically on either side of a central axis 69. FIG. 13 shows portions of two parallel drive electrodes 68. Each drive electrode 68 may be formed by a repeating pattern of identical electrode shapes 70 connected in series by conductive links 71. The conductive links 71 may be arranged along the central axis 69 of the drive electrode 68.

Each of the electrode shapes 70 may be a substantially square shape with projections 76a-76d having a substantially square annular channel 72 extending around a substantially square central section 73. Each of the electrode shapes 70 may have substantially the same external shape as the electrode shapes 39 illustrated in FIG. 8 and the electrode shapes 59 illustrated in FIG. 11. The electrode shapes 70 may be formed by a substantially square body 74. Edges of the body 74 may have the same orientation as the edges of central section 73 and the annular channel 72 so that the electrode shape 70 has a substantially square perimeter 75 having a constant width and formed by four side portions 75a to 75d each having the same width, and a substantially square central portion 73 electrically isolated from the substantially square perimeter 75 by the substantially square annular channel 72.

Each of the electrode shapes 70 may be arranged so that a diagonal of each of the substantially square body 74 and the substantially square central portion 73 are both aligned with the central axis 69. Thus, the outer edges of the substantially square bodies 74 and the edges of the substantially square central portions 73 making up the drive electrode 30 may be at a 45° angle to the central axis 69.

The vertices of the body 74 and central section 73 which extend away from the central axis 69 may be truncated. Accordingly, the shape of the body 74 and central section 73 may be described as substantially square.

Each of the four side portions 75a to 75d of the substantially square body 74 may have a respective protruding part or projection 76a to 76d extending radially outward. Each of the projections 76a to 76d may extend outward perpendicular to a respective side portion 75a to 75d. The projections 76a to 76d may be arranged so that if two lines are drawn between the points of contact of projections 76a to 76d and the respective side portions 75a to 75d from which they project on opposite sides of the body 74, these lines may intersect at the center of the body 74. In some arrangements where the length of the part of each side portion 75a to 75d obscured by a conductive link 71 is substantially the same as the length of the part of that side portion 75a to 75d removed by truncation, the projections 76a to 76d may project from the mid-points of the side portions 75a to 75d.

The drive electrodes 68 may be similar to the drive electrodes 57 of FIG. 12 modified to have the central gap 61 partially occupied by a central portion 73. In some examples, the drive electrodes 68 may be used to replace the drive electrodes 57 in the combined electrode pattern 66 illustrated in FIG. 12.

The illustrated examples have drive electrodes and sense electrodes formed on two opposed faces of a substrate. In other examples the drive electrodes and sense electrodes may be formed on the same surface of a substrate. In such examples, the crossing of the conductive links of the drive electrodes and the sense electrodes may be carried out using a conductive crossover element. In other examples, the drive electrodes and sense electrodes may be formed on opposed faces of different substrates.

In some examples, the electrodes may be formed of a conductive metal. Examples of a suitable conductive metal include copper and gold. In some examples, the electrodes may have a thickness in the range 10 μm to 50 μm. In one example, the electrodes may have a thickness of 30 μm. In other examples, the conductive lines may be formed by sputtering metal onto a substrate and subsequent etching of the metal. In some examples, the electrodes may be formed of ITO.

In some examples, the substrate may be formed of glass. In other examples, the substrate may be formed of an insulating polymer. One suitable insulating polymer is polyethylene terephthalate (PET).

In the illustrated example of FIG. 1, the electrodes and connecting lines are encapsulated by covering sheets and adhesive layers. In some examples, some or all of the covering sheets and/or adhesive layers may be omitted.

While the above discussion is pertinent to mutual capacitance drive approaches, self-capacitance drive methods may be similarly improved by application of the technologies discussed in the examples above.

Various modifications may be made to the examples described in the foregoing, and any related examples may be applied in numerous applications, some of which have been described herein. It is intended by the following claims to claim any and all applications, modifications and variations that fall within the true scope of the present disclosure.

1. A panel for a touch-screen comprising:
at least one substrate;
a plurality of first electrodes arranged on the at least one substrate in a first direction;
a plurality of second electrodes arranged on the at least one substrate in a second direction different than the first direction, wherein:
the plurality of first electrodes and the plurality of second electrodes are comprised of a conductive material, and
each of the plurality of second electrodes comprises a repeating pattern of hollow shapes connected in series.

2. The panel of claim 1, wherein each of the hollow shapes comprises a rhombus-shaped portion having four side portions which form a perimeter around a gap,
each side portion has a protruding portion extending outward from each side portion, and
a width of each side portion is greater than a thickness of each side portion.

3. The panel of claim 2, wherein the rhombus-shape is a square.

4. The panel of claim 2, wherein the protruding portion extends radially from a mid point of the side portion.

5. The panel of claim 2, wherein the protruding portion extends in a direction substantially perpendicular to the side portion.

6. The panel of claim 2, wherein each side portion has a width of from 0.2 mm to 0.5 mm.

7. The panel of claim 2, wherein each protruding portion has a width of from 0.2 mm to 0.5 mm.

8. The panel of claim 2, wherein the width of each side portion is substantially equal to the width of each protruding portion.

9. The panel of claim 2, wherein the gap covers an area greater than the combined area covered by the four side portions.

10. The panel of claim 2, wherein the thickness of each side portion is from about 10 μm to about 50 μm.

11. The panel of claim 2, wherein the thickness of each protruding portion is from about 10 μm to about 50 μm.

12. The panel of claim 2, wherein the thickness of each side portion is substantially equal to the thickness of each protruding portion.

13. A panel for a touch-screen comprising:
a substrate having a first face and a second face opposite the first face;
a plurality of first electrodes arranged on the first face in a first direction; and
a plurality of second electrodes arranged on the second face in a second direction different than the first direction, wherein:
the plurality of first electrodes and the plurality of second electrodes are comprised of a conductive material, and
each of the plurality of second electrodes comprises a repeating pattern of hollow shapes connected in series.

14. The panel of claim 13, wherein each of the hollow shapes comprises a rhombus-shaped portion having four side portions which form a perimeter around a gap,
each side portion has a protruding portion extending outward from each side portion, and
a width of each side portion is greater than a thickness of each side portion.

15. The panel of claim 14, wherein each protruding portion extends radially from a mid point of the respective side portion.

16. The panel of claim 14, wherein each protruding portion extends in a direction substantially perpendicular to the respective side portion.

17. The panel of claim 14, wherein each side portion has a width of from 0.2 mm to 0.5 mm.

18. The panel of claim 14, wherein each protruding portion has a width of from 0.2 mm to 0.5 mm.

19. The panel of claim 14, wherein the width of each side portion is substantially equal to the width of each protruding portion.

20. The panel of claim 14, wherein the gap covers an area greater than the combined area covered by the four side portions.

21. The panel of claim 14, wherein the thickness of each side portion is from about 10 μm to about 50 μm.

22. The panel of claim 14, wherein the thickness of each protruding portion is from about 10 μm to about 50 μm.

23. The panel of claim 14, wherein the thickness of each side portion is substantially equal to the thickness of each protruding portion.

24. The panel of claim 14, wherein the rhombus-shape is a square.

25. A series of electrodes, wherein:
each electrode in the series comprises a repeating pattern of rhombus-shaped portions connected in series, each of the rhombus-shaped portions having four corner portions and four side portions which form a perimeter around a gap,
each side portion has a protruding portion extending outward from each side portion,
a width of each side portion is greater than a thickness of each side portion,
the electrode is aligned such that a center axis traversing each repeating pattern of rhombus-shaped portions passes through two oppositely aligned corner portions, and
each of the side portions is aligned at a 45 degree angle with the center axis.
